(19) United States
(12) Patent Application Publication
(10) Pub. No.: US 2014/0082016 A1
(43) Pub. Date: Mar. 20, 2014

(54) AUTOMATED PERSONAL INFORMATION SHARING SYSTEM AND METHODS

(71) Applicant: Joseph M. Vanek, Clarendon Hills, IL (US)

(72) Inventor: Joseph M. Vanek, Clarendon Hills, IL (US)

(21) Appl. No.: 13/617,829

(22) Filed: Sep. 14, 2012

(51) Int. Cl. G06F 17/30

(52) U.S. Cl. 707/770; 707/E17.032; 707/E17.108

(57) ABSTRACT

Information is automatically identified and shared between individuals who wish to become socially or professionally “connected.” An electronic communication is sent from one person to another including a request or invitation to be personally connected. If the request is accepted by the other person, a computer network is automatically accessed without further user intervention to search of one or more electronic databases to locate information related to the persons. If such information is found during the search, it is provided to the persons wishing to be connected. The initial request to become connected may be sent through an electronic mail message, through physical contact between two smartphones or other portable electronic devices, or through a wireless electronic network communication. The method may include searching multiple Internet websites or electronic databases, including social or professional media Internet websites, to locate the information to be shared.

### FIELD OF THE INVENTION

This invention relates generally to social networking and, in particular, to a system and methods whereby personal or professional contact information is automatically located and shared to strengthen connections between users.

### BACKGROUND OF THE INVENTION

There are tremendous social and personal benefits that arise when people connect with one another, as many of the social ills that affect large urban populations arise from a false sense of anonymity. This tendency has been studied in cyberspace by many academics, as evidenced by John Suler's article The Online Disinhibition Effect, Suler, J. (2004). CyberPsychology and Behavior, 7, 321-326. The underlying theme of these studies is that people will say and do unproductive things in real and virtual social groups when they believe that they are anonymous. The inverse is also true, productive behavior tends to increase as people feel connected to and accountable to a community.

On the worldwide web several efforts have been made to connect people to enhance their social experience. These social media sites have helped remove the veil of anonymity, but contain severe limitations in that they are largely accessed through desktops and laptops, provide limited information, do not connect all sources of information, and do not provide results in a coherent manner at the point in time when the information can be best utilized. As a result, users often lose interest, and do not fully engage in social and professional communities by adding contacts and inviting additional connections. Users also have difficulty harvesting productive results from the effort invested.

### SUMMARY OF THE INVENTION

This invention resides in methods for automatically sharing information between individuals who wish to become socially or professionally “connected.” As part of the method, an electronic communication is sent from one person to another including a request or “electronic invitation” to be personally connected as friends or colleagues. If the request is accepted by the other person, a computer network is automatically accessed without further user intervention to search of one or more electronic databases to locate information related to the persons. If such information is found during the search, it is provided to the persons wishing to be connected. While a “person” in this context is ordinarily an individual, organizations or other entities may also use the invention.

The request to become connected may be initiated by two or more users who allow their smartphones or handheld computers to link, either through an exchange of email, or through an electronic message or data link established by physical contact between the devices. The information exchanged during the initiation process includes information adequate to identify the party or parties so that a search can be performed designed to establish the connections between the parties. Once an electronic data exchange has occurred each party is presented with the option to “start” or “begin” the process, which process may include the steps of searching databases that are resident on the computer devices or external databases. Advantageously, the information may be common to, shared by, or somehow link the two persons. For example, one or more contact lists maintained by the persons may be searched to identify common contacts.

The method may include the step of providing user controls enabling the persons to limit the type of databases to be searched or the information to be shared. Messages to the persons or to a third party may automatically be generated to announce or confirm that the connection has been made. Such a message may include information regarding a time or place associated with the connection. Image databases may be searched to automatically provide the persons with digital images of each other.

Information regarding the movements or travels of the persons may be uncovered and shared. For example, such movements or travels may be identified using global positioning system (GPS) data to inform the persons if or when they have been in the same geographic region, business establishment, or event. The method may further include the steps of determining if the persons, who have previously connected, are physically near one another, and informing the persons if they are in close proximity. Various mechanisms may be used to determine proximity, including electronic proximity sensing techniques like Bluetooth or GPS data.

### BRIEF DESCRIPTION OF THE DRAWINGS

FIG. 1 is a block diagram showing the way in which database results are returned in response to requests;

FIG. 2 is a flow diagram showing how searches are conducted and results are returned in response to an initiated connect;

FIG. 3 is a flow diagram showing how searches are conducted and results may be presented to third parties in response to an initiated connect;

FIG. 4A is a screen display illustrating how a link may be established;

FIG. 4B is a screen display asking a participant whether searches should be initiated using names;

FIG. 4C is a screen display asking a participant if local and/or remote database searches should be conducted;

FIG. 4D is a screen display asking a participant what types of information they are willing to share; and

FIG. 4E is a screen display associated with remote databases.

### DETAILED DESCRIPTION OF THE INVENTION

The inventions disclosed herein integrate multiple sources of personal and professional information in a manner that provides useful results at the point of need, i.e., when individuals meet for the first time in a dynamic setting such as a business meeting or restaurant. The inventions disclosed herein also provide security to individuals meeting in public social settings by documenting the time and place of meeting and alerting third parties that the meeting has taken place. The inventions disclosed herein also encourage people to fully engage with the social media sites that they are connected to as that will help elevate the quality of the search results described herein.

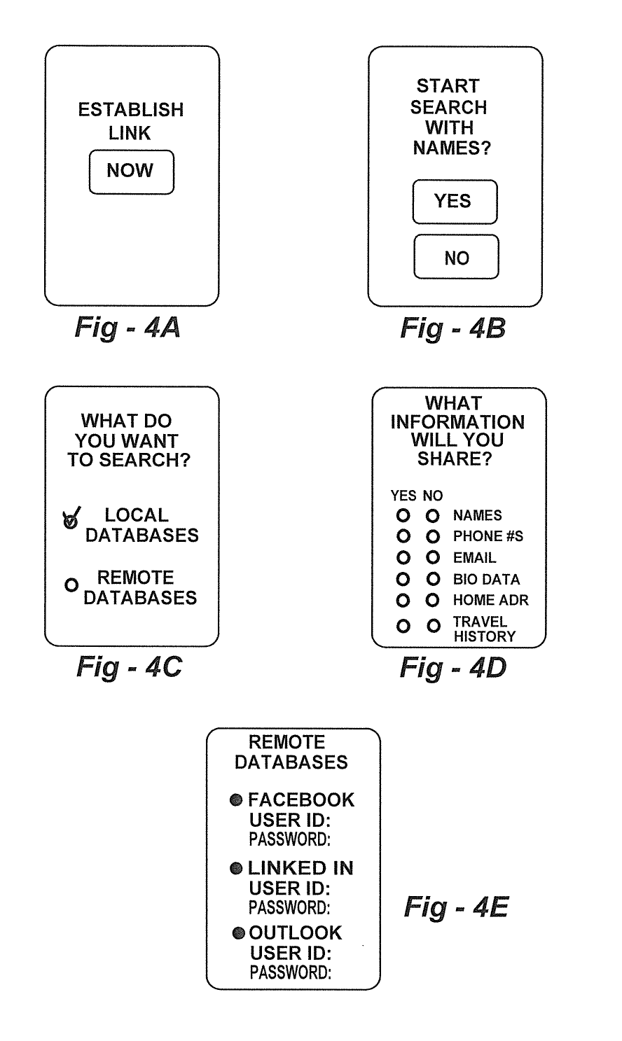

In broad and general terms, the invention involves a two-step process: (1) users choose to make a connection with one another and, once that happens, (2) comprehensive search and connection processes are invoked. The consent to connect with another person or organization can be initiated through an invitation sent via email, or initiated through the clicking of phones together, or through a wireless connection. The invention is not limited in this respect. For example, FIG. 4A is a screen display illustrating how a link may be established using a touch screen on a smart phone. This may be followed by the screen display of FIG. 4B, asking a participant whether searches should be initiated using names.

Once the consent to connect has been established a number of different steps may be taken. For example, the system may identify and deliver relationship results between people or organizations through a single source of information, thereby avoiding the need for multiple database queries. Thus, if both individuals have social media accounts, such as Facebook or Linked In, a connection request can be transmitted to one of those databases, the connections established, and the results transmitted to the requestors. FIG. 4E, for example, is a smart phone screen display associated with remote databases in the form of social media sites.

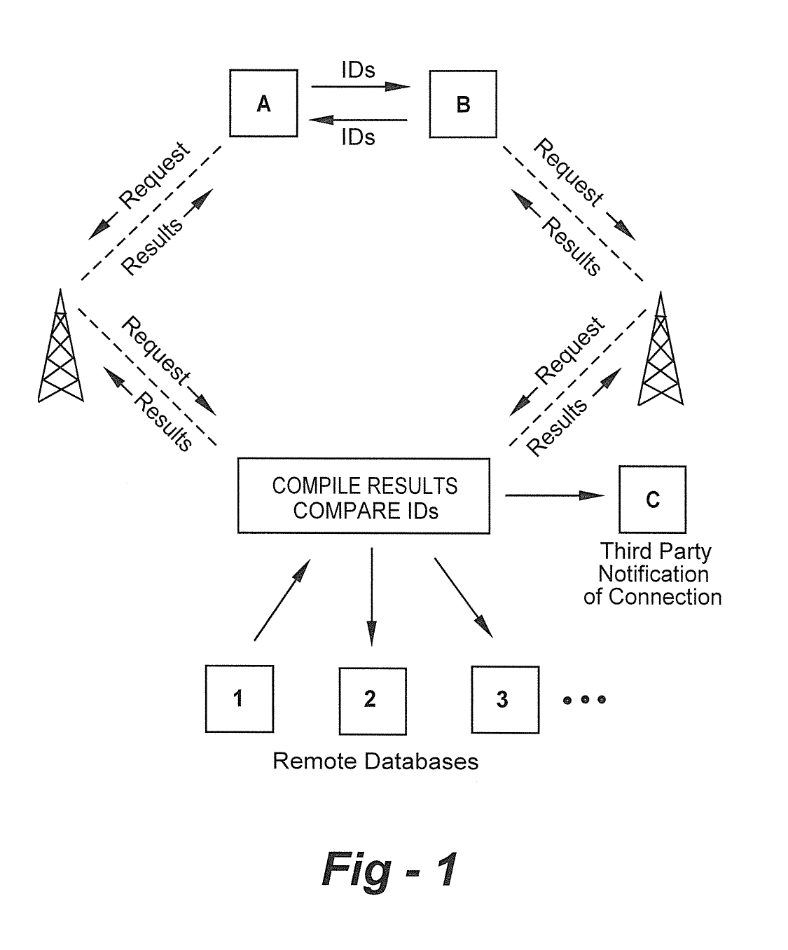

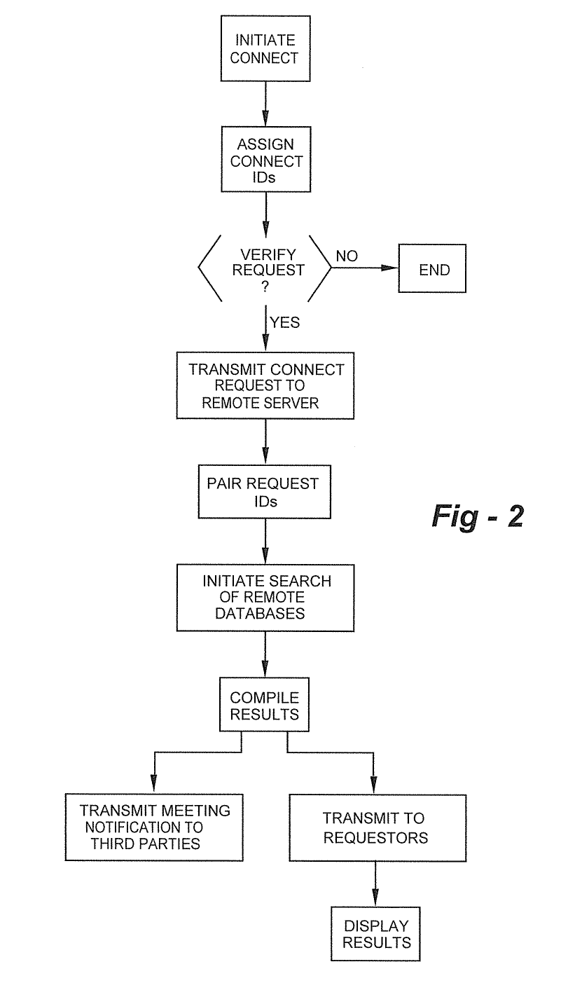

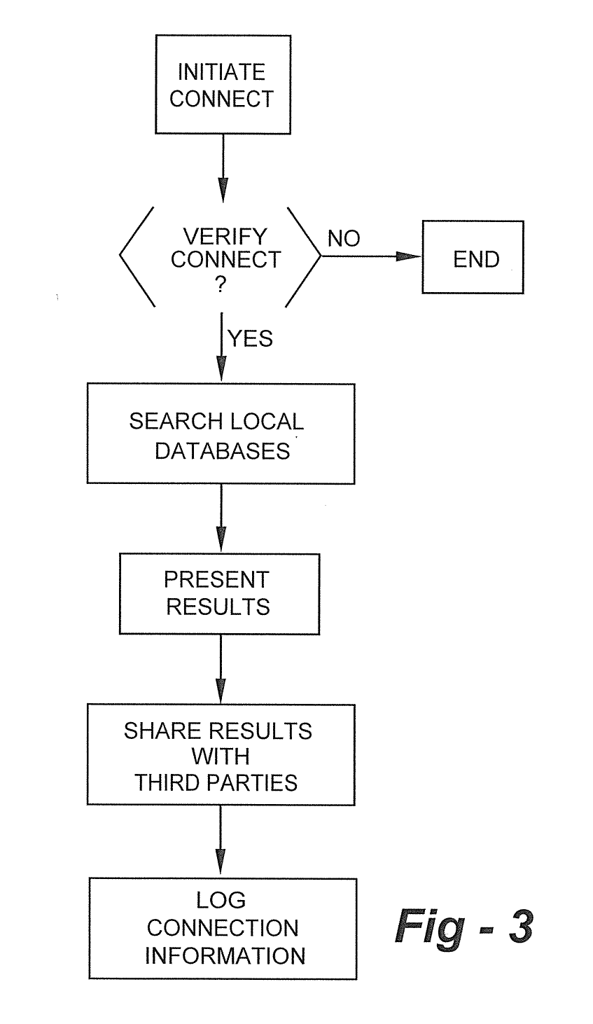

In the preferred embodiment, the connect request is sent to a computer capable of sending queries to a variety of information locations, retrieving data related to the requestors and, upon the receipt of the data, assembling the search results, which are then transmitted to the persons who have made the request. FIG. 1 is a block diagram showing the way in which these database results are returned in response to requests, and FIG. 2 is a flow diagram showing how searches are conducted and results are returned in response to an initiated connect. FIG. 3 is a flow diagram showing how searches are conducted and results may be presented to third parties in response to an initiated connect. The range of categories that can be searched for a relationship or connection is varied. For example, a search may be performed of each person's contact list contained in a computer program such as Outlook for an overlap of friends.

Searches may also be performed in social media sites as previously mentioned, and searches may access personal preference information such as that type of information commonly collected from computer search histories and consumer spending habits to determine if there are shared common interests. For example, if a stored data site has information indicating both requestors share an interest in surfing, that result may be returned to the requestors. Indeed, the extent to which various biological, health, financial, personal, educational and demographic information can be searched to form a basis for providing the connection results to the requestors is only limited by the extent to which that information is stored on databases that can searched.

User controls may be provided that permit each requestor to limit the type of information that will be searched and/or shared. These user controls or user preferences can be established via an interface on a mobile phone application or via an account established on a standard website accessed via the worldwide web and a computer. The user controls or preferences can limit both the number and nature of the databases accessed as well as the information contained within any particular database. For example, a user may wish to limit the search to friends contained within their Facebook page, or only wish to compare their contact listings, such as those found in Microsoft's Outlook program. FIG. 4C is an example screen display asking a participant if local and/or remote database searches should be conducted, and FIG. 4D is a screen display asking a participant what types of information they are willing to share.

In the event two persons wish to connect the user restrictions may limit the scope of the search that is performed. In the event that the settings are so restrictive that a search cannot be adequately performed, a user warning or alert can be provided to the requestors so that the requestors have the opportunity to adjust the restrictions and perform a full search.

In addition to providing connection results to the requestors, the preferred embodiment can also automatically send a message to the individuals that form the connection between the requestors that the requestors have met. This message can provide date, time and location information. For example, if person X is a common connection between requestors Y and Z, person X can receive a text or email indicating that on Apr. 1, 2012 at 9 p.m. X and Y met at ABC restaurant in Chicago, Ill. Optionally, the requestors can also be provided the opportunity to take and transmit a photograph of themselves to the individuals that form the connection between them. Messages to individuals that foam the connection between requestors can be initiated by the requestors if those messages are not sent automatically according to the user preferences.

The invention may also provide the opportunity for the requestors to adjust and post their settings on social media sites that they both participate on. For example, they could automatically or selectively become linked or connected on the social media site or the fact that they met could be automatically posted on that site.

Another alternative implementation is for the connection results to be generated within one or both of the requestor's mobile computing and/or smart phone platforms. These implementations would require personal data to be previously entered or downloaded and stored onto the requestors mobile computers. The information would be shared and results generated upon a connection request being agreed to by one or both requestors. For example, contact lists may be populated on both ends with phone numbers, email addresses, dates such as birthdays, photographs, etc.

Generated connection results may also be based on the requestors' spatial and temporal histories. Spatial and temporal histories are compiled both by GPS type functionality being utilized on mobile computing platforms, subjective entries made to social media platforms, and travel records stored by a variety of travel companies. This feature would compare, for example, the movements of each of the requestors over the past year as logged in their mobile computing platform or as logged on various remote databases. Possible connection results could include, without limitation, the fact that they both visited a particular city, a particular restaurant, attended a particular sporting event on the same date. A comparison of the requestors temporal and spatial information can also be used to predict when and where it would be most convenient for the requestors to meet again. For example, the requestors can be advised that they are likely to meet again at a particular restaurant, coffee shop, or health club at a particular time.

Another possible implementation of the system disclosed herein is to use spatial and temporal information of people in a common area to alert each user whether there are other persons with whom they are connected, or closely related, nearby. For example, as a result of the transmission of GPS information to a central processor, the processor can compare the various social media connections of all other persons it knows is also presently located at that location. Results can then be sent back to a requester indicating that they have linked to several other people at that event, such as a concert, and provide the requestor with their names. In addition the processor can determine whether there are people present that have only one, or two, degrees of separation from each other and provide those results to the requestors so that they may meet. In such circumstances the name of the other requestor can be shielded until both requestors agree to share their identity to the other.

A further feature would be to provide alerts in the future based on the proximity of the individuals. For example, once a connection is established between two persons a variety of proximity sensing strategies can be used to alert those individuals that they are close to each other. Those proximity strategies can include, for example, a blue tooth type connection, GPS data transmitted and compared on a common database with results being retransmitted back to the now-connected individuals.

1. A method of connecting people, comprising the steps of:
sending an electronic communication from one person to another containing a request to be personally connected as friends or colleagues;
if the request is accepted by the other person, automatically accessing a computer network to search of one or more electronic databases to locate information related to the persons; and, if information is found during the search,
providing the information to the persons.

2. The method of claim 1, wherein the request is sent through an electronic mail message.

3. The method of claim 1, wherein the request is sent through contact between two smartphones or other portable electronic devices.

4. The method of claim 1, wherein the request is sent through a wireless electronic network communication.

5. The method of claim 1, wherein a person may be an organization or other entity.

6. The method of claim 1, including the step of searching a social or professional media Internet website to locate the information.

7. The method of claim 1, including the step of searching multiple Internet websites or electronic databases to locate the information.

8. The method of claim 1, wherein the information related to the persons includes information common to, shared by, or linking the two persons.

9. The method of claim 1, including the step of searching one or more contact lists maintained by the persons to locate common contacts.

10. The method of claim 1, including the step of locating and providing biological, health, financial, personal, educational or demographic information to the persons.

11. The method of claim 1, including the step of providing user controls enabling the persons to limit the type of databases to be searched or the information to be shared.

12. The method of claim 1, including the step of automatically sending a message to the persons or to a third party indicating that the connection has been made.

13. The method of claim 1, including the step of automatically sending a message to the persons or to a third party including information regarding a time or place associated with the connection.

14. The method of claim 1, including the step of locating and providing the persons with digital images of each other.

15. The method of claim 1, including the steps of:
locating information regarding the movements or travels of the persons; and
informing the persons if or when they have been to the same geographic region, business establishment, or event.

16. The method of claim 1, including the steps of:
locating information regarding the movements or travels of the persons using global positioning system (GPS) data; and
informing the persons if or when they have been in the same geographic region, business establishment, or event.

17. The method of claim 1, including the steps of:
determining if the persons are physically near one another; and
informing the persons if they are in close proximity.

18. The method of claim 1, including the steps of:
determining if the persons are physically near one another using electronic proximity sensing techniques; and
informing the persons if they are in close proximity.

19. The method of claim 1, including the steps of:
determining if the persons are physically near one another using global positioning system (GPS) data; and
informing the persons if they are in close proximity.
